(19) United States
(12) Patent Application Publication
(10) Pub. No.: US 2011/0273790 A1
(43) Pub. Date: Nov. 10, 2011

(54) Unfolding film-type radiation reflector

(76) Inventors: Abdulla Sirazhutdinovich Aliev, (US); Felix Gadgiahmedovich Kaziahmedov, Makhachkalinskaya (RU)

(21) Appl. No.: 12/262,856

(22) Filed: Oct. 31, 2008

(30) Foreign Application Priority Data
May 2, 2006 (RU) PCT/RU2007/000080

(51) Int. Cl. G02B 7/188

(52) U.S. Cl. 359/846

(57) ABSTRACT

The invention relates to space engineering, and can be used for space radio, television and telephone communications, as well as illuminating ground objects at night from space. The inventive unfolding film-type radiation reflector comprises a framework consisting of pneumatic tubes and cells, a film reflecting surface connected to the framework along the perimeter thereof and a gimbal assembly mountable on a space vehicle. The internal and external frames of the gimbal assembly are made from internal and external wheel-shaped pneumatic tubes. The internal wheel-shaped pneumatic tube is embodied in such a way that it is mountable on the space vehicle, while the external wheel-shaped pneumatic tube is embodied in the form of a framework element and is connected to the film reflecting surface. Said invention makes it possible to reduce the mass and overall dimensions of mechanisms for packing and unfolding the film-type radiation reflector.

### CROSS-REFERENCE TO RELATED APPLICATION

This application claims the benefit of the priority filing date in PCT/RU2007/000080 referenced in WIPO Publication WO/2007/139434. The earliest priority date claimed is May 2, 2006.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The invention relates to space engineering, more specifically, to space communication engineering. The technical result achieved by realization of the invention lies in the reduction of weight and dimensions of devices for folding and opening the film radiation reflector.

The main point of the invention is the developed construction which permits a large-size mirror sheet to be packed, transported, and unfolded, and its orientation better controlled in space in accordance with a preset program.

There is a known radiation reflector that consists of an external pneumatic chamber and radial supports in the form of perforated flexible tubes supplied with pneumatic cells. These pneumatic cells interact between themselves and with the mirror sheet, which in turn is connected to the internal pneumatic chamber and the filler (source of gas).

However, the known radiation reflector does not possess constructional details that allow packing and spreading out from the folded position. This defect makes it difficult to transport the reflector, unfold it in space, and control its orientation.

Also known in the art is a “Solar sailing vessel” (SSV) with a film radiation reflector which, by its constructional features, may be specified as the prototype for the present invention.

The prototype has a case, main and additional flexible tubes, and devices to control the orientation of the main and additional flexible tubes. Means of surface formation are realized as pneumatic systems.

Control means for flexible reflecting surfaces are made in the form of gimbal suspensions with electric drives placed outside the SSV. External frames of the gimbal suspensions have corresponding means for forming flat reflecting surfaces and devices for their unfolding.

However, placement of electric drives for orientation and rolling up the reflecting surfaces on the gimbal suspensions outside the spacecraft (SC) increases their weight and dimensions and makes folding and transporting the reflector more difficult. The prototype does not provide for the folding of the flexible surface (reflecting sheet) for transportation and the constructional details used for its spreading out from the folded position.

The technical task consists of working out such construction of the radiation reflector that can ensure the folding, transportation and spreading out of the reflecting sheet, as well as reducing the weight and dimensions of the devices for unfolding and controlling the orientation of the radiation reflector.

### SUMMARY

The technical task of working out a construction of the radiation reflector that can ensure the folding, transportation and spreading out of the reflecting sheet, as well as reducing the weight and dimensions of the devices for unfolding and controlling the orientation of the radiation reflector, is solved by introducing into the case of the radiation reflector the following kinematically connected devices: the flexible reflecting mirror and the means for formation, in the form of pneumatic systems, and the control means for the orientation of the flexible reflecting surface, mounted on the gimbal suspensions.

In this case, gimbal suspensions are made in the form of first and second concentric pneumatic chambers interacting with each other and kinematically connected by axes and shafts with the corresponding electric drivers for orientation fixed on the case of the SC. The concentric pneumatic chambers and the pneumatic system for surface formation are pneumatically connected with the source of filling (e.g. gas).

The second variant of the radiation reflector additionally includes the first spinup electric motor, and kinematically connected to it, the first freely rotating drum installed on the case. The drum has the second and third electric motors for orientation and filler sources (gas) rigidly affixed to it.

In the third variant of the unfolding film radiation reflector, the second and third electric motors for orientation are installed in such a way that the orientation directions of their shafts coincide with the orientation direction of their radial pneumatic supports. Here, the second electric motor is installed on the SC case rigidly, while the third one is installed by hinges, freely revolving around the rod and oriented along the shaft of the second motor and interacting with the shaft.

In the forth variant of the unfolding film radiation reflector, the second and third electric motors for orientation and the first and second gas fillers are installed in symmetrical pairs along the long axis of the SC case at its bow (or stern). The case of the second electric motor is rigidly connected to the bar with the second gas filler, while the case of the third electric motor (along with the rigidly connected first gas filler) is fastened by hinges, with the help of brackets, to the bar that is installed on the shaft of the unrolling motor affixed to the SC case.

In this variant, the flexible reflecting surface has the form of a circle and is packed by being rolled up from four sides in two perpendicular directions coinciding with the direction of the radial pneumatic supports.

In the second variant, the flexible reflecting surface in the form of a circle is folded sector by sector like accordion bellows in such a way that the filling of the pneumatic cells on the radial supports is realized from the center to the periphery, whereupon the pneumatic cells of the external pneumatic chamber are filled.

In both variants of the radiation reflector, radial pneumatic supports and the external pneumatic chamber have pneumatic valves installed in a certain manner.

In this situation, the pneumatic valve has a tube with two radial and two longitudinal apertures. In the tube, there is a spring-loaded small ball that interacts with the compressed gas inside the flexible tube and the “tongs-like” ends of the two second springs installed at both diametrically opposite ends.

### FIGURES

FIG. 1 is the construction of the present invention:

(1) case of the spacecraft (SC),

(2) drum,

(3) the first motor of unrolling,

(4,5) the second and the third electric motors for orientation,

(6,7) the first and second culring shafts,

(8) filler source,

(9) hose,

(10,11) the first and second concentric pneumatic chambers,

(12,13) the first and second hinge joints,

(14) external (the third) pneumatic chamber,

(15) radial pneumatic supports

(16) mirror sheet,

(17) taut bands,

(18,19) the first and second curling axes,

(20) pneumatic valve,

FIG. 2 shoes the hinge joint 13 of the curling axis 6 with the first pneumatic chamber wherein:

(21) is the tubular tip,

(22) is the sleeve,

(23) is the ring,

(24) is the connecting pipe

FIG. 3 shows the joint of the drum spinup, where positions 1-9 repeat the positions of FIG. 1:

(25) wheel.

FIG. 4 shows the design of the second curling shaft 7, wherein:

(26,27) are the first and second gimbal suspensions,

(28) is the spider,

(29) is the guide,

(30) is the slide-block,

(31) are the guiding tabs (wires),

(32) are the slots,

(33) is the spring,

(34) are the links of the curling shaft,

(35) are the hinge joints,

(36) is the cylindrical tip of the shaft 7.

FIG. 5 shows the A-A sectional view of the curling shaft 7 as in FIG. 4, where positions 26-36 repeat the positions of FIG. 4.

FIG. 6 shows the film reflector 16 as in FIG. 1 rolled up from two sides along the OX axis as viewed from the SC end.

FIG. 7 shows the B view as in FIG. 6, where the mirror sheet 16 of the reflector is rolled up from two sides.

FIG. 8 shows the C view of the reflecting film as in FIG. 7, rolled up from four sides.

FIG. 9 shows the K view as in FIG. 8, where the reflecting film is rolled up from four sides and covered with the casing 37.

FIG. 10 shows the second variant of packing the reflecting film for transportation, where positions 1-21 repeat the positions of FIG. 1:

(38) lines of the reflector deflection towards the observer (forward)—firm lines,
(39) lines of the reflector deflection in the counter direction (backwards)—dash-dots,

(40) additional (the fifth-sixteenth) radial pneumatic supports,

(41) crosses and circles indicate preferred points to install pneumatic valves for optimal and quick release of the mirror sheet,

(42) pneumatic chambers have the toroidal form,

(43) flexible tube,

(44) bushing,

(45) radial apertures,

(46) longitudinal apertures,

(47) nipple,

(48) cylindrical spring,

(49) flat springs with the pliers-like tips,

(50) slots,

(51) the first plug,

(52) ball.

FIG. 12 shows the design of the second variant of the pneumatic valve 20, where positions 42-52 repeat the positions of FIG. 11, wherein:

(53) is the second bushing,

(54) is the second plug,

(55) are the elastic bands.

FIG. 13 shows the N-N sectional view as in FIG. 12, where positions 42-55 repeat the positions of FIG. 11 and FIG. 12.

FIG. 14 shows the third variant of the pneumatic valve, where positions 42-54 repeat the positions of FIG. 12.

(56) elastic diaphragm,

(57) cup.

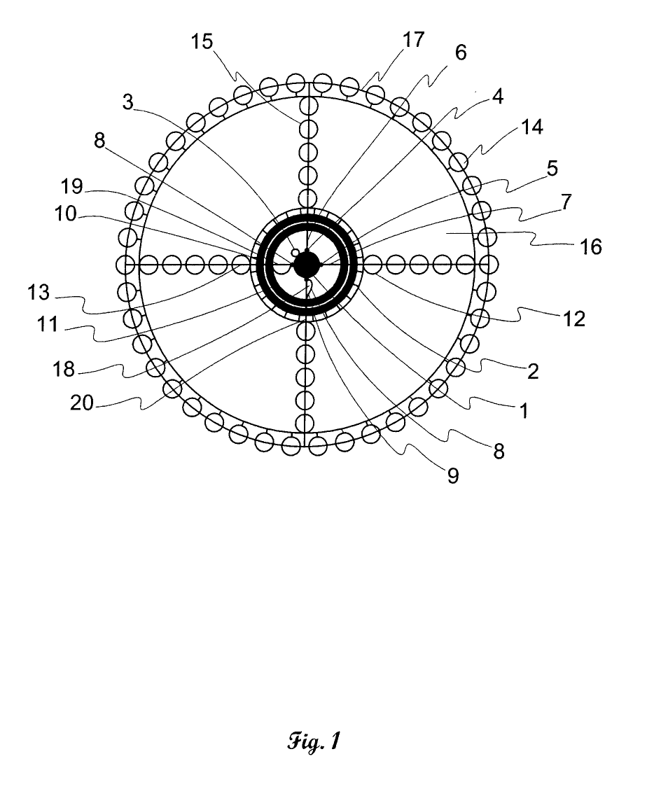

FIG. 15 shows the third variant of placing the orientation motors 4 and 5 and filler sources (compressed gas) 4, where positions 4-19 repeat the positions of FIG. 1.

(58) bar,

(59) hinge joints,

(60) brackets,

(61) r-type lever,

(62) the second filler source (gas),

(63) pneumatic valve,

(64) column of the spinup electric motor,

(65) adjusting flange,

(66) fingers (pins).

### DESCRIPTION

The principle of unfolding the film reflector shown in FIGS. 1-10 comprises the following: Film radiation reflectors intended for space radio, television and telephone communication, as well as for illuminating ground objects from space at night, must be of several hundred meters in diameter and installed in unmanned aircrafts. On the ground, the reflecting sheet 16 should be folded and packed in such a way as to secure its automatic release and control in space according to a preset program. The entire construction of the film reflector is mounted on the drum 2 that is installed on the cylindrical spacecraft (SC) with the ability for free rotation. The drum starts rotation with the help of the spinup electric motor 3. The motor is rigidly attached to the SC case and interacts with the drum through the wheel 21.

The second 4 and third 5 electric motors for orientation, together with the filler sources (e.g. compressed gas) 8, 62, are fixed rigidly on the rotating drum 2. The storage sources (gas) 9 and electric motors 4, 5 are arranged along the perimeter of the drum in every 90° and are matched and balanced in weight in relation to the axis of the drum rotation.

FIG. 3 shows the design of the spinup joint. The drum 2 is mounted on the SC case 1 with the ability for free rotation. The second 4 and third 5 spinup electric motors, together with the filler sources (gas) 8, 62, are arranged and affixed along the perimeter of the drum. Two filler sources are used as counterbalances. They should be selected in accordance with the weight of the electric motors 4 and 5. The wheel 25 placed on the electric motor shaft 3 interacts with the drum and brings it into rotation. Under the action of centrifugal forces created by rotation of the drum and by parallel straightening effect of the pneumatic supports 15 and the external pneumatic chamber 14, the mirror sheet 16 takes a flat round form.

The drum may be also in the form of a rotating stator [FIG. 3]. In this case the first electric motor is of no necessity.

The mirror sheet may be sped up by rotation of the SC case with the help of jet motors.

Release of the mirror sheet may be done without speeding it up. In this case the rotating stator, the drum and the spinup motor 3 are not needed.

To control the orientation of the mirror sheet in relation to the SC case, gimbal suspensions are used by interacting the first (internal) 10 and second (external) 11 pneumatic chambers. In this case, the shaft of the second electric motor 4 interacts with the first pneumatic chamber 10 by means of the first curling shaft 6, whereas the shaft of the third electric motor 5 interacts with the second pneumatic chamber by means of the gimbal shaft and the second curling shaft 7. Diametrically opposite points of the mentioned pneumatic chambers (gimbal suspensions) are joined at the hinges to the tips of the corresponding curling axes 18, 19.

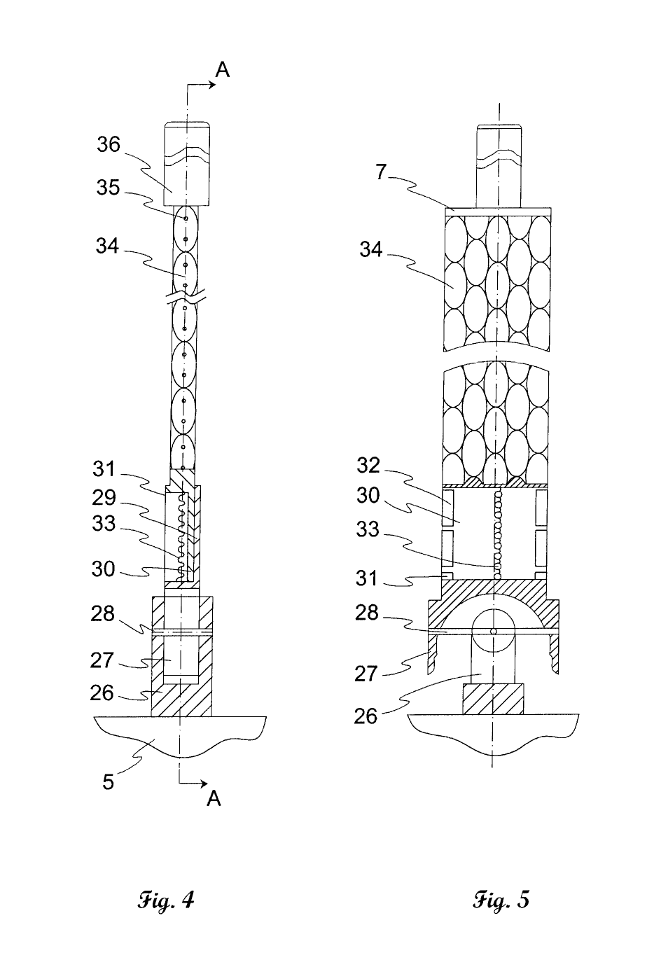

The curling shafts 6, 7 and the axes of rotation 18, 19 are designed in the form of a strip consisting of links connected at the hinges similar to the links of a wristwatch bracelet (see FIG. 4 and FIG. 5). Such shafts and axes are freely roll up in one plane into a cylindrical pack ready for transportation. The unfolded reflector, the mentioned shafts, and the axes take a flat form and transmit rotation from the electric motors 4,5 to the corresponding concentric pneumatic chambers 10, 11. In the mode of rotation, they work as rigid shafts and axes that allow the changing orientation of the pneumatic chambers 10, 11 within the angles ±β and ±α correspondingly.

Design of the second curling shaft 7 displayed in FIG. 4 and FIG. 5 is more elaborate than that of the first shaft 6. This is due to the necessity for transmitting rotation at different angles and for different distances. Such situations arise when the first pneumatic chamber 10 rotates within the ±β angle with the help of the electric motor 4.

The gimbal shaft, consisting of the first 26 and second 27 gimbal suspensions and the spider 28, is included in the design of the second curling shaft 7 in order to transmit rotation at an angle to the second pneumatic chamber 11. The first gimbal suspension is made from the shaft of the motor 5 itself. A similar attachment design is seen in the gimbal of the curling axis 19. Constructional elements 29-33 are included in the design of the second curling shaft 7 and the axis 19 to perform the function of controlled elongation. Design of this joint is analogous to the design of the office stapler. The guide 29 is a rectangular plate bended at four sides. Its lower end is joined to the second gimbal suspension 27. The laterals of the guide 29 have narrow longitudinal slots 32 in which the guiding tabs 31 of the slide-block 30 move. The upper end of the guide 29 has a groove in which the slide-block 30 freely moves. The upper end of the spring 33 is attached to the upper end of the slide-block bent at right angles. The lower end of the spring is fastened to the lower end of the guide 29. In this way, the length of both the second curling shaft and the curling axis is regulated. Links 34 are connected to each other by hinges similar to the links of a wristwatch bracelet.

The lower line of the links 34 is fastened to the upper end of the slide-block 30. The uppermost line of the links—connected at the hinges, making a flexible chain—is rigidly attached to the cylindrical tip 36 of the shaft 7. The tips 36 of the shaft 7 and the axis 19 are free to go through the corresponding sleeves 22, disposed in the sections of the first pneumatic chamber on both diametrically opposite sides. Then, the tip 36 of the shaft is rigidly attached to the second concentric pneumatic chamber 11 and changes its orientation within the ±a angle.

After that, the spinup motor becomes disconnected. Then, the chains of the power supply, for the electric motors for orientation 4 and 5 and for unfolding the reflector 16, are connected with the help of the relay or contact switch.

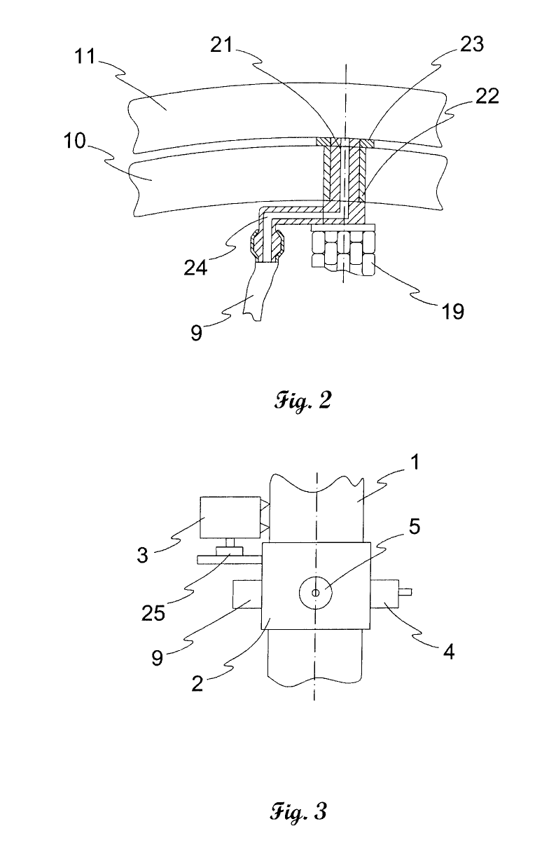

Unlike the shafts 6 and 7, the axes' ends 18 and 19 have tubular tips 21 and connecting pipes through which the filler (gas) is fed into the first and second pneumatic chamber (see FIG. 2).

Design of the first curling shaft 6 is devoid of the gimbal (details 26-28) and the joint of lengthening (details 29-33). In all other respects their elements are identical. The tip of the first curling shaft 6 is rigidly fixed to the first concentric pneumatic chamber 10 and rotates it by the ±β angle.

The second curling axis 19, like the first shaft 7, includes the gimbal (details 26-28) and the joint of the axis lengthening (details 29-33). In other respects, axes 18 and 19 are identical in design.

Unlike the first axis, the tip 21 of the second axis 19 goes through the sleeve 22 in the first concentric pneumatic chamber 10 and hermetically connects the cavity of the second pneumatic chamber 11 with the second filler source (gas) 62.

The tubular tip of the first axis 18 connects the cavity of the first concentric pneumatic chamber 10 with the first filler source (gas) 8. The filler (gas) is fed through the electric pneumatic valve 63 and the hose 9. If the spinup electric motor is used, the electric pneumatic valve can be of a radio-controlled type.

To feed the filler (gas) to the second concentric pneumatic chamber 11, the end of the second axis has a rigidly and coaxially joined tube 21 that is connected with the filler source (gas) 8 by the connecting pipe 24 and the hose 9. The tip of the tube 21 is rigidly attached to the second concentric pneumatic chamber 11 whose inner cavity pneumatically communicates with the filler source (gas) through the pneumatic valve 63. If the reflector is unfolded under remote programmed control, the pneumatic valve may be replaced by the radio-controlled electropneumatic valve. The sleeve 22 is rigidly fixed in the second hinge joint 13 along the radial section of the first pneumatic chamber and provides rotation of the second chamber in relation to the first one within the ±α angle.

The first hinge joint 12 differs from the second one in the following manner: the tip of the first curling axis 18 rotates in the sleeve installed like the second one along the OY axis in the first pneumatic chamber 10. Thus, the electric motor 4 helps to change the orientation of the first pneumatic chamber within the ±β angle. In this case, the electric motor 5 controls orientation of the second pneumatic chamber 11 within the ±α angle.

The second pneumatic chamber is rigidly connected to the radial pneumatic supports 15 arranged along the rotation axes OX and OY. Also, the inner cavity of the mentioned pneumatic chamber communicates with the inner cavities of the radial pneumatic supports 15 through pneumatic valves 20. The pneumatic valves secure the given direction and the order of filling the pneumatic cells of the radial pneumatic supports 15 and the external (the third) pneumatic chamber 14 by the filler (gas).

This variant of packing the reflecting sheet 16 displayed in FIG. 4-FIG. 7 requires the following order of filling: first the radial supports 15 oriented along the OY axis should be filled by gas, then the radial supports 15 oriented along the OX axis from the center to the periphery. Additional radial pneumatic supports 15 are also filled from the center to the periphery. The external pneumatic chamber is the last to be filled simultaneously in four directions from the OY axis, or in two directions from every pneumatic support.

After the external pneumatic chamber takes the form of a circle, the taut bands 17 connected with the second and the external (the third) pneumatic chambers stretch the mirror sheet from all sides in radial directions until the mirror sheet takes the flat round form.

Arrangement of the pneumatic valves, their carrying capacity, and the distance between two neighboring valves, determine the rate of filling individual parts of radial pneumatic supports and the external pneumatic chamber.

To provide the necessary quickness in unfolding the mirror sheet 16, it is possible to use centrifugal forces appearing at the drum 2 spinup. This is done with the help of the first electric spinup motor 3 which has the wheel 25 mounted on its shaft. It is possible to achieve the necessary rate of unfolding the mirror sheet by regulating the speed of rotation of the drum, to which the packed mirror sheet is connected, and with the use of the preset program for filling the pneumatic cells.

However, the mirror sheet can also be unfolded with the help of only the pneumatic system without resorting to the spinup. In this case, design of the reflector is considerably simpler.

FIG. 6 shows the mirror sheet 16 after being rolled up from two sides along the OX axis.

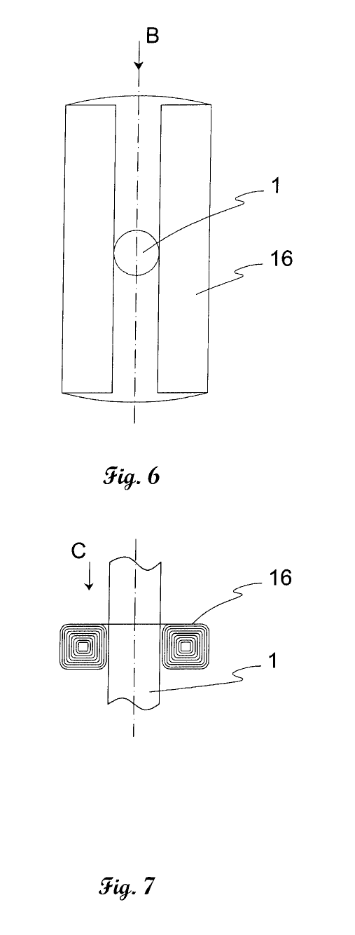

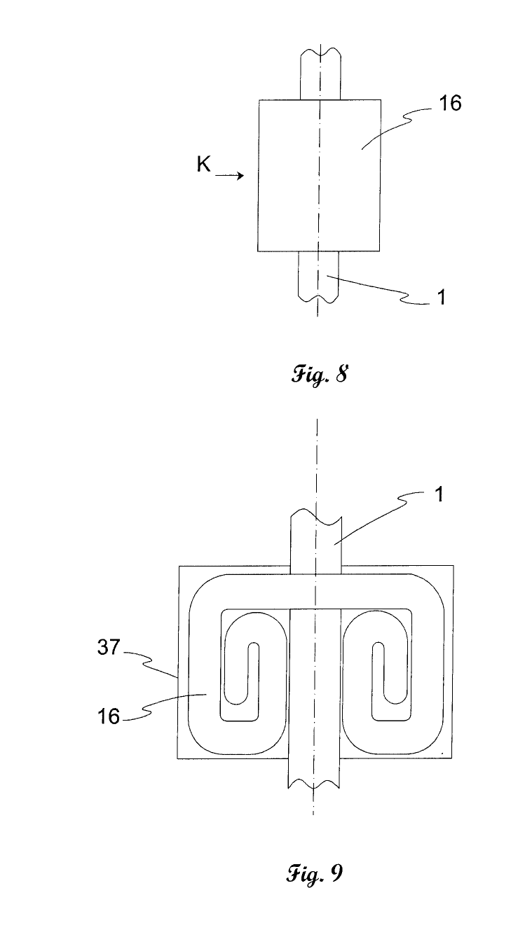

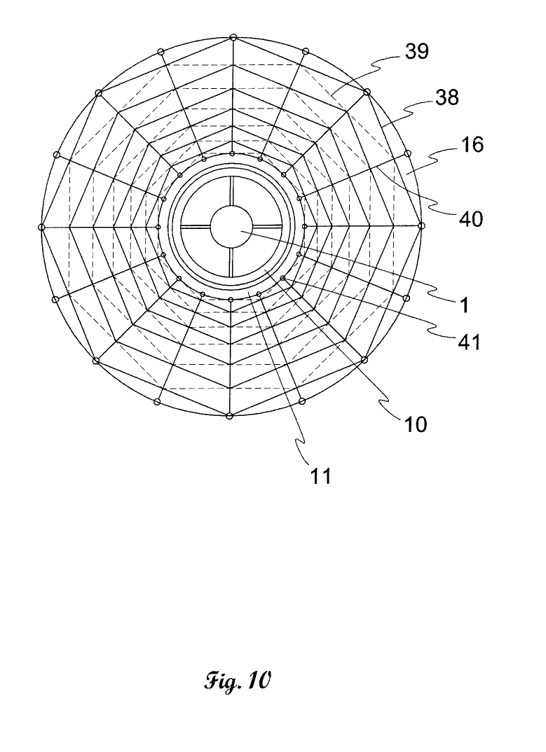

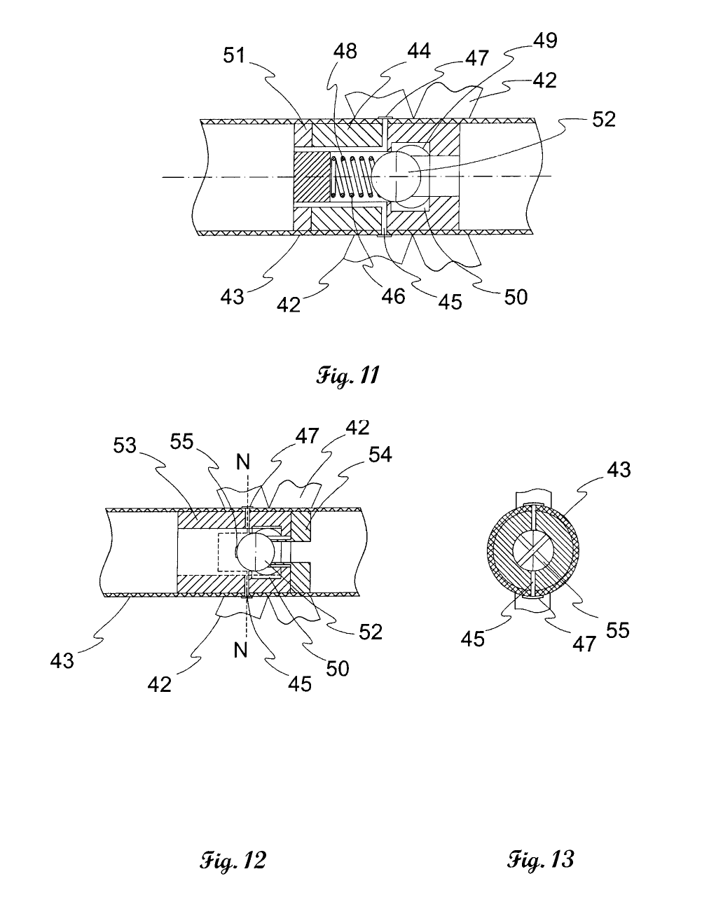

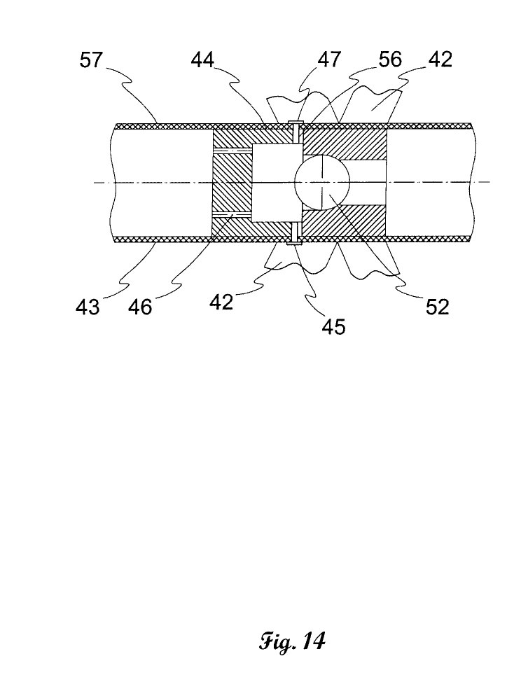

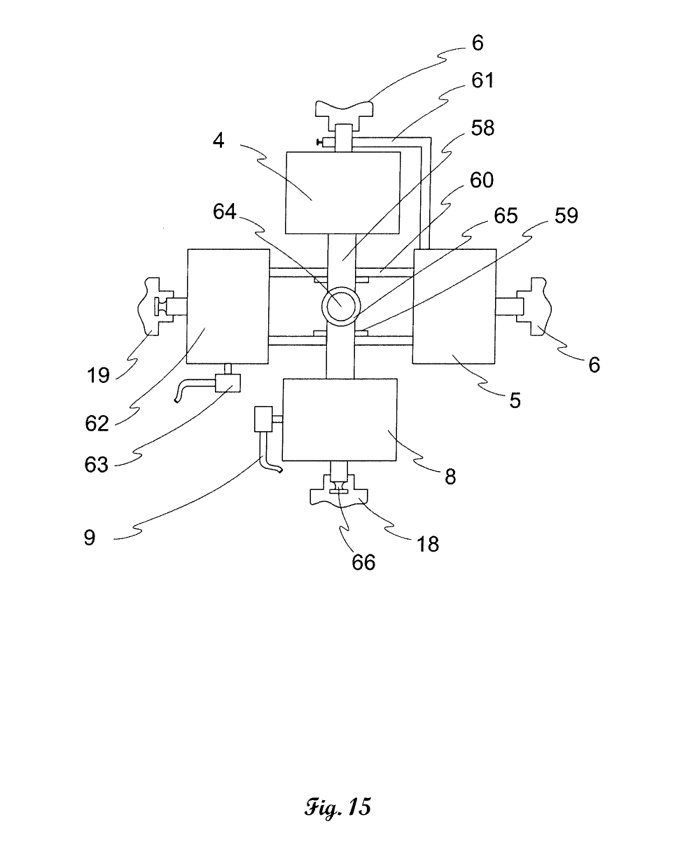

FIG. 7 shows the B view by FIG. 6. The crosses 41 (FIG. 10) denote the arrangement of pneumatic valves on the radial supports 15. Pneumatic valves ensure the necessary rate of the mirror sheet release. The lesser the number of pneumatic valves, the more their carrying capacity, and the less the time needed for the mirror sheet 16 to release.

FIG. 8 shows the C view of the mirror sheet by FIG. 7 after it is rolled up from two sides along the OY axis.

FIG. 9 shows the K view of the mirror sheet by FIG. 8 after it is rolled up from four sides along two axes.

The mirror sheet rolled up from four sides is adjusted to the SC case from two sides and occupies the least volume.

To protect the mirror from outside damage, it is covered by the casing 37, which consists of two collapsible parts.

Once delivered to space, the rolled up mirror sheet is unfolded in the opposite order. The collapsible parts of the casing 37 are cast away. First, the sheet is released along the OY axis by filling the pneumatic supports oriented along the OY axis with its simultaneous spinup. Then, the pneumatic supports oriented along the OX axis are straightened. This succession is achieved with the help of valves meant for higher pressure P₂.

When centrifugal forces are used for unfolding the mirror sheet the drum is simultaneously rotated with the help of the electric motor 3. With that end in mind it is possible to rotate the SC case with the help of jet engines.

The third variant of arrangement of the motors 4, 5 and the filler sources (of gas) 8 (see FIG. 15) is used when the radiation reflector is placed at the bow or stern of the SC; in particular, when the reflector is used as a solar sail, or for illuminating ground objects with solar radiation at night, or as a reflector in space radio, television and telephone communication.

The column (or the shaft of the spinup motor) 64 is oriented along the longitudinal axis of the SC case.

The reflector is attached to the column by the flange 65. The adjusting flange has the form of a cylinder whose end is rigidly attached to the bar 58. Two symmetrical ends of the bar have the electric motor for orientation and for the filler source 8 coaxially and rigidly fixed. Both filler sources 8, 62 must be equivalent to the electric motors 4, 5 in form and weight.

If there is no need for the spinup of the reflector, one filler source is used instead of two. It may be installed in any place on SC board. In this case, the shaft of the third electric motor 5 is oriented along the OX axis, i.e. at right angles with the shaft of the second electric motor 4 coinciding with the OY axis. The third electric motor of orientation 5 and the second filler source 62 are attached to the bar 58 by two brackets 60 and the hinge joint 59, with the ability for free movement revolving around it.

The shaft of the second electric motor 4 is rigidly fixed to the upper end of the ┌-shaped lever 61. The lower end of this lever is also connected to the case of the third electric motor for orientation 5. This connection secures the changes in orientation for the second curling shaft 7 in accordance with variations in orientation of the first concentric pneumatic chamber 10. In this case, the curling shaft is of equal length which eliminates the necessity for the gimbal shaft (positions 26-28) and constructional elements (29-33) to lengthen the curling shaft.

With the small diameters of the first 10 and second 11 concentric pneumatic chambers that can be achieved in the third variant of the reflector design, there is no need for the curling shafts 6, 7 and the axes 18, 19. They may be replaced by rigid shafts and axes made in the form of cylindrical rods. The heads of the curling axes 18, 19 are set on the fingers (pins) 66 with the ability for free rotation (see FIG. 15).

To prevent separation of the axes from the fingers 66, the axes have grooves in which the tips of screws rotate. The tips of screws are wrung up in the bushings which are fixed in the root parts of the curling axes 18, 19.

Fingers (pins) 66 fixate the position of the curling axes and are rigidly attached to the cases of the corresponding filler sources (of gas) 8, 62 along the direction of the OX and OY axes. Thus, fingers 66 are attached coaxically to the corresponding curling shafts 6, 7.

The disposition and weight of the electric motors 4 and 5, as well of the two filler sources 8, 62 with the attached shafts 6, 7 and axes 18, 19, must be chosen in such a way to secure the balance of centrifugal forces as they revolve around the shaft 64 of the spinup electric motor (not shown in FIG. 15).

In space conditions of weightlessness, it is possible to release the reflecting sheet without the spinup, using only the straightening force of the pneumatic cells. In this case, there is no need in using the spinup devices. They are needed if the diameters of the reflector are large, which excite gyro forces that hinders orientation control.

FIG. 11 displays the design of the first variant of the pneumatic valve 20. The valve includes the cylindrical bushing 44 which has the ball 52 and the spring 48 placed inside it. One end of the spring abuts against the ball, while the other end abuts against the plug 51. The aperture at the other end of the tube is of smaller diameter. The spring-loaded ball hermetically stops the aperture in the tube. The ball lets gas pass into the adjoining pneumatic cell if pressure in the previous cell exceeds the P₁ level. Once this level is exceeded, the spring 48 contracts and the ball lets gas into the next pneumatic cell through the aperture 46 in the bushing 44 and the tube 45.

FIG. 12 displays the design of the second variant of the valve 20. The valve also consists of the cylindrical (second) bushing 53, the ball 52, two elastic bands 56 fixed in mutually perpendicular directions, and the second plug 51. The aperture 45 in the flexible tube coincides with the aperture 46 of the valve.

Unlike the first variant (FIG. 11), the ball stops the aperture in the bushing 53 owing to the tensile force of the elastic bands 55. Once the pressure exceeds the preset P₁ level, the elastic bands extend, the ball is loosened, and gas is fed into the next pneumatic cell through the aperture 45.

To achieve this effect, the design of the valve (see FIG. 11 and FIG. 12) should be supplied by two tongs-like flat springs 47. At one end, these springs are fixed rigidly to the bushing 42 (49), while the other tongs-like ends abut against the ball 43 from two diametrically opposite sides. Pressing forces of the springs are directed to the center of the ball along the same, single line and mutually compensate each other. Once the pressure level P₁ in the previous pneumatic cell is exceeded, the ball shifts to the left, the tongs-like ends of the springs 47 push the ball out in the same direction and fixate the opened position of the valve.

Operating principle of the third variant of the pneumatic valve (see FIG. 14) consists of the following. Like the second variant of the pneumatic valve, the ball 52 stops the aperture of the second plug 54. The elastic diaphragm 56 presses the ball to the spherical indent at the end of the second plug. By varying the thickness and force of elasticity of the diaphragm material, it is possible to find the pressure level at which the pneumatic valve 20 functions. Once the allowable pressure level is exceeded, the diaphragm expands, the aperture in the diaphragm widens, and the ball is pushed out through the aperture of the diaphragm. The ball enters into the bushing 57 cavity, the filler (gas) is fed into the bushing cavity, slightly raising the nipple 47 and going into the cavity of the pneumatic cell 42 through radial apertures 45. For better reliability, the aperture 46 in the cylindrical tube 42(49) may be built over the nipple 53 which lets gas in through only one direction. Pneumatic cells may also be filled with the hardening foam dielectric [FIG. 1].

The pneumatic cells may have toroidal or spherical form. Toroidal pneumatic cells can be arranged to form a chain. Toroidal pneumatic cells are smaller in weight and volume than spherical ones.

The hardening foam dielectric used as the filler enhances reliability of the radiation reflector.

The valves can be disposed in the joints of the radial pneumatic supports 15 with the second pneumatic chamber.

The pneumatic valves filling the external (third) pneumatic chamber 14 (denoted by circles in FIG. 10) can be calculated for pressure P₂ higher than P₁ at which the radial pneumatic supports are filled.

Valves of this kind, calculated for different pressure values P₁ and P₂, could be used for gradual release of the folded mirror sheet 16, first along the axis OY, then along the axis OX (see FIG. 7).

Thus, all pneumatic cells are gradually filled one after another forming the radial supports 15 and the external pneumatic chamber 14. In this way the whole system is filled.

In case separate pneumatic cells are damaged, the system retains its form because the valves do not admit gas into the damaged pneumatic cell. In this way, reliability and durability of the whole system is enhanced.

Like the prototype, the main and supplementary flexible reflecting surfaces can be released as it was described above.

A film radiation reflector can be used as a solar sail in an unmanned aircraft and for illuminating ground objects by solar radiation at night.

Sources of information used in drawing up the present application are the following: Aliev, A. S., Tagirov D. T. Film radiation reflector. Patent RU # 2207675, 7H01Q15/14, G 02 B5/12. Apr. 1, 2002; Aliev, A. S., Kaziakhmedov F. G. Solar sailing vessel. Patent RU . . . by the application # 2003128353/11 of Sep. 19, 2003; Syromyatnikov, V. S., Bryants, N. V., Koverina, I. P. Spacecraft with the solar sail. RU, Patent # 2053940, Dec. 10, 1996.

What is claimed is:

1. An unfolding film radiation reflector comprising the following, kinematically connected:
a flexible reflecting mirror and means of formation made in the form of pneumatic systems including concentric pneumatic chambers connected with each other by radial pneumatic supports;
control means for orientation of the flexible reflecting surface that are installed on gimbal suspensions;
gimbal suspensions made in the form of interacting the second and third pneumatic chambers, kinematically connected through axes and shafts, with a corresponding first and second electric motor for orientation, made with the possibility of rigid installation on the spacecraft case, the pneumatic chambers and pneumatic system of means of the surface formation are pneumatically coupled with the filler source (e.g. gas), while the second pneumatic chamber is connected with the third (external) pneumatic chamber by radial supports.

2. An unfolding film radiation reflector as in claim 1, wherein said radial pneumatic supports and the third (external) pneumatic chamber further comprise pneumatic valves disposed in the joints of radial pneumatic supports with the second and third (external) pneumatic chamber.

3. An unfolding film radiation reflector as in claim 2, wherein the pneumatic valve has the bushing, inside of which are a cylindrical spring, a plug, a ball, and flat springs with tongs-like tips; the whole designed with the ability of freely admitting the filler at excess of the set pressure level; the flat springs with the tongs-like tips made capable of fixating the opened position of the valve.

4. An unfolding film radiation reflector as in claim 2, wherein the pneumatic valve has the bushing inside of which are the ball, two elastic bands fixed in mutually perpendicular directions and interacting with the ball, the plug, and flat springs with the tongs-like tips; the whole designed with the ability of freely admitting the filler at excess of the set pressure level; the flat springs with the tongs-like tips made capable of fixating the opened position of the valve.

5. An unfolding film radiation reflector as in claim 2, wherein the pneumatic valve has the bushing, the plug, the ball, the cup and the diaphragm made as a washer of elastic material interacting with the ball and disposed between the bushing and the cup; the whole designed with the ability of freely admitting the filler at excess of the set pressure level.

6. An unfolding film radiation reflector as in any one of claim 2, 3, 4, or 5, wherein the flexible reflecting surface has the form of a circle and is packed by being rolled up from four sides in two perpendicular directions coinciding with the direction of the radial pneumatic supports.

7. An unfolding film radiation reflector as in any one of claim 2, 3, 4, or 5, wherein the flexible reflecting surface has the form of a circle and is packed by being folded in sectors like accordion bellows in such a way that the filling of the pneumatic cells on the radial supports is realized from the center to the periphery followed by the filling of the external pneumatic chamber.

8. An unfolding film radiation reflector comprising:
kinematically connected flexible reflecting surface and means of formation made in the form of pneumatic systems including concentric pneumatic chambers connected with each other by radial pneumatic supports;
control means for orientation of the flexible reflecting surface which are installed on gimbal suspensions;
gimbal suspensions made in the form of interacting the second and third pneumatic chamber, kinematically connected through axes and shafts with the corresponding first and the second electric motor for orientation;
the reflector further comprising the kinematically connected spinup electric motor and the drum made with the ability for installation on the spacecraft case and for free rotation; the drum, in turn, having the first and the second electric motor for orientation and the filler source (e.g. gas) rigidly installed; the pneumatic chambers and pneumatic system of means of the surface formation being pneumatically connected with the filler source, while the second pneumatic chamber being connected with the third (external) pneumatic chamber by the radial supports.

9. An unfolding film radiation reflector comprising:
kinematically connected flexible reflecting surface and means of formation made in the form of pneumatic systems including concentric pneumatic chambers connected with each other by radial pneumatic supports; control means for orientation of the flexible reflecting surface which are installed on gimbal suspensions;
gimbal suspensions made in the form of interacting the first and second pneumatic chamber, kinematically connected through axes and shafts with the corresponding first and second electric motor for orientation, while the second pneumatic chamber is connected with the third (external) pneumatic chamber by the radial supports;
the reflector further comprising the first and second filler source (e.g. gas) equivalent in form and weight to the electric motors for orientation and pneumatically connected with the pneumatic chambers and the pneumatic system of means of surface formation; said electric motors of orientation and filler sources made with the ability for pairwise symmetrical installation about the longitudinal axis of the spacecraft case; the case of the second electric motor for orientation being rigidly connected with the second filler source by the bar and made with the ability for rigid connection, preferably at the bow or stern parts, to the spacecraft case; the shaft of the second electric motor for orientation being fixed to the upper end of the ┌-shaped lever whose lower end is attached to the case of the first electric motor for orientation; said case of the first electric motor for orientation having the first filler source rigidly attached to it with the aid of brackets mounted, at the hinges, on the bar with the ability for freely revolving around it.

10. The unfolding film radiation reflector comprising:
kinematically connected flexible reflecting surface and means of formation made in the form of pneumatic systems including concentric pneumatic chambers connected with each other by radial pneumatic supports;
control means for orientation of the flexible reflecting surface which are installed on gimbal suspensions;
gimbal suspensions made in the form of interacting the first and second pneumatic chamber, kinematically connected through axes and shafts with the corresponding first and second electric motor for orientation, while the second pneumatic chamber is connected with the third (external) pneumatic chamber by the radial supports;
the reflector further comprising the first and second filler source (e.g. gas) equivalent in form and weight to the electric motors for orientation and pneumatically connected with the pneumatic chambers and the pneumatic system of means of surface formation; said electric motors for orientation and the filler sources being made with the ability for pairwise symmetrical installation about the longitudinal axis of the spacecraft case; the case of the second electric motor for orientation being rigidly connected with the upper end of the r-shaped lever by the bar mounted on the shaft of the spinup electric motor and designed with the ability for matching with the longitudinal axis of the spacecraft case; the lower end of said ┌-shaped lever being attached to the case of the first electric motor for orientation while said first electric motor for orientation has the first filler source rigidly attached to it with the aid of brackets and set up on the rod by the hinges with the ability for freely revolving around the rod.
